(19) United States
(12) Patent Application Publication
(10) Pub. No.: US 2005/0002769 A1
(43) Pub. Date: Jan. 6, 2005

(54) Pivoting material / equipment lift

(76) Inventor: Craig Carl Scheibel, Sarasota, FL (US)

Correspondence Address: AMERICAN INGENUITY INC, 1720 ALTA VISTA STREET, SARASOTA, FL, 34236, US

(21) Appl. No.: 10/839,103

(22) Filed: May 5, 2004

Related U.S. Application Data
(60) Provisional application No. 60/468,068, filed on May 6, 2003.

(51) Int. Cl. B60P 1/00

(52) U.S. Cl. 414/540

(57) ABSTRACT

A pivoting lift attached to a vehicle which includes a mounting assembly, a pivoting guide assembly with a lift means, a vertical elongate assembly, and a load holding member for raising or lowering a load into and out of a vehicle, such that the load can be fully or partially supported by each level during the loading and unloading process. Further embodiments of the invention include a pivoting load holding member, and a trolley mounting means allowing for placement of the loads in different positions in the vehicle.

### FIELD OF THE INVENTION

The present invention relates generally to a pivoting lift attached to a vehicle which includes a mounting assembly, a lift assembly, and a load holding member for raising or lowering a load into and out of a vehicle, such that the load can be fully or partially supported by each level during the loading and unloading process.

### BACKGROUND OF THE INVENTION

Heavy and bulky material or equipment are difficult to handle both from different heights and different locations. The material or equipment used, however, must be readily transportable from one location to another. For instance, a large equipment storage box or generator may be used at a variety of different job sites, and will typically be hauled from one site to the next by a pickup truck or van.

One problem with transporting such equipment is the loading or unloading of the equipment into and out of the vehicle. Often the material or equipment is too heavy to manually load or unload without risk of injury, or it must be broken down into smaller sections, requiring numerous trips to move it from the vehicle to a work location. Consequently additional people are required, a hoist or forklift is used, or the vehicle is equipped with a lift.

However most lifts are expensive, require a lot of time to attach to the vehicle and they are not easy to load or unload. Usually it is very difficult to secure the load while raising or lowering. Only if the vehicle is dedicated to transportation of material or equipment, can the cost of the lift be justified. Additionally lifts available presently, suspend the load at the upper level and require the operator to move the load off of a suspended load holding member, across gaps between the lift and vehicle.

It would be advantageous to have a low cost removable lift that did not sag, have gap issues when loading or unloading, and could be used for other lifting situations away from the vehicle.

### SUMMARY OF THE PRESENT INVENTION

The present invention relates generally to a vehicle mounted pivoting material or equipment lift that moves items from one level to another. The lift gives the user a more economical alternative, often with little or no installation costs to raise or lower material in or out of a vehicle. The pivoting or swing feature makes it easier for the user to load and unload since the load holding member can be pivoted toward, and over the other level, then lowered onto it. This provides a stable surface for loading and unloading. Other lifting solutions will sag or have uneven transitions and gaps, making it more difficult and possibly unsafe to load or unload. Additionally if one uses an item such as a forklift, pallet jack, dolly, or other device to load/unload the load holding member, the lift assembly does not have to support this additional weight, since the load holding member can be fully or partially supported by the structure of each level.

One specific application of this invention is for loading and unloading items from a vehicle such as a pickup truck, van, or trailer. To date, lifts associated with these types of vehicles require the operator to load the item onto the load holding member and then transfer the load off the suspended load holding member onto the second level. With this invention one pivots the load over the vehicle, and the operator never has to go out onto the suspended load holding member to load or unload items. Additionally, most lifts associated with vehicles require a lot of work to install. Many require modifications or welding for installation. With the depicted versions of the invention they can all be mounted either by simply securing an adapter in a hitch receiver, or with minor bolting of an adapter to the vehicle. There are many different styles of mounting adapters and load holding members, each with a specific application advantage.

### BRIEF DESCRIPTION OF THE DRAWINGS

The invention will hereafter be described with reference to the accompanying drawings, wherein like referenced numerals denote like elements, and;

FIG. 1 is a perspective view of a lift with an elongate member mounted to a hitch adapter. The unit is shown in the transit position facing into the vehicle with the elongate member in contact with the adjustable stop and the load holding member tilted to contact the vehicle bed. The vehicle factory tailgate has been removed and an optional sliding up/down tailgate kit is installed.

FIG. 2 is a perspective view of the lift with an elongate member pivoted out/away from the vehicle with the elongate member in contact with the ground and the load holding member in tilted to contact the ground. The sliding tailgate is removed for loading.

FIG. 3 is a perspective view of the lift with an elongate member in the fully raised position and turned halfway from facing out to in, toward the vehicle.

FIG. 4 is an exploded perspective view of the lift with an elongate member at the ground level disconnected from the hitch adapter mounting means, and the hitch adapter mounting means disconnected from the vehicle.

FIG. 5 is a perspective view of the lift with an elongate member mounted to a swing out hitch adapter. The hitch adapter is fully extended away from the vehicle and the support foot engages the ground. The vehicle factory tailgate is open and the unit is turned, facing into the vehicle.

FIG. 6 is a perspective view of the lift with an elongate member mounted to a swing out hitch adapter. The hitch adapter is pivoted to the left position and the support foot is in the transit position. The load holding member is pivoted up and the vehicle factory tailgate is closed.

FIG. 7 is a front perspective exploded view of 3 of 4 main assemblies of the lift with an elongate member and a pivoting load holding member.

FIG. 8 is a rear perspective exploded view of 3 of 4 main assemblies of the lift with an elongate member and a pivoting load holding member.

FIG. 9 is a front perspective view with hidden lines of the lift with an elongate member and a pivoting load holding member.

FIG. 10 is an exploded perspective view of the pivot guide assembly with a hand crank winch lifting means.

FIG. 11 is an exploded perspective view of the pivoting load holding member.

FIG. 12 is a perspective view of the pivoting load holding member with the tilt arm in the lower position, showing how the tilt rollers move away from the elongate member.

FIG. 13 is a perspective view of the pivoting load holding member with the tilt arm in the upper position, showing how the tilt rollers move toward the elongate member.

FIG. 14 is a perspective view of the lift with an elongate member mounted to a straddle base accessory, to allow use of the lift away from the vehicle.

FIG. 15 is a perspective view of the swing arm hitch adapter mounting means in the left position with a raised support foot.

FIG. 16 is a perspective view of the swing arm hitch adapter mounting means in the extended position with a lowered support foot.

FIG. 17 is a perspective view of the swing arm hitch adapter mounting means in the right position.

FIG. 18 is a perspective view of the swing arm hitch adapter mounting means in the left position.

FIG. 19 is a perspective view of the swing arm hitch adapter mounting means in the extended position.

FIG. 20 is a perspective view of the standard straight hitch adapter mounting means.

FIG. 21 is a perspective view of the standard fixed offset hitch adapter mounting means.

FIG. 22 is a perspective view of the extension receiver tube hitch adapter mounting means. (Allows use of the hitch even when a lift is attached.)

FIG. 23 is a front view of the swing arm hitch adapter mounting means in the extended position with hidden lines showing the partial pin contour cutout in the pivoting member end.

FIG. 24 is a top view of the swing arm hitch adapter mounting means in the extended position with hidden lines shown.

FIG. 25 is a right side view of the swing arm hitch adapter mounting means in the extended position with hidden lines shown.

FIG. 26 is a perspective view of the lift with an elongate member with a trolley mounting means. The factory tailgate is removed. The unit is shown facing away from the vehicle, wheels on the bottom of he elongate member are engaging the ground level. Forks are shown for the load holding member. The pivoting guide assembly handle is extended, to allow a user to operate the unit from the ground level to the side of the vehicle. Inverted “V” trolley tracks are shown.

FIG. 27 is a perspective view of the lift with an elongate member with a trolley mounting means, and a non-pivoting load holding member is mounted to the elongate member by a second guide means. The factory tailgate is removed. The unit is shown in the raised position pivoted halfway towards the vehicle. Forks are shown for the load holding member.

FIG. 28 is a perspective view of the lift with an elongate member with a trolley mounting means, and the load holding member mounted to the elongate member by a second guide means. The factory tailgate is removed. The unit is shown pivoted toward the vehicle. The trolley is moved forward in the truck, and the elongate member and forks are lowered to engage the truck bed.

FIG. 29 is a front perspective exploded view of 3 of 4 main assemblies of the lift with an elongate member and a non tilting load holding member which mounts to the elongate member by a second guide means.

FIG. 30 is a rear perspective exploded view of 3 of 4 main assemblies of the lift with an elongate member and a non tilting load holding member which mounts to the elongate member by a second guide means.

FIG. 31 is a front perspective view with hidden lines of the lift without a mounting adapter. The load holding member is mounted to the elongate member by a second guide means. In this instance the load holding member is a pair of adjustable forks.

FIG. 32 is a perspective view of a 55 Gallon drum in an set of load holding members, made to attach to the lift elongate member directly or with a second set of guide means.

FIG. 33 is a perspective view of a pivot arm mounting means for box vans, trailers and other applications.

FIG. 34 is a perspective view of a pivot arm mounting adapter with the lift mounted to a box van. The unit is shown pivoted into the van, and lowered.

FIG. 35 is a perspective view of the trolley mounting adapter assembly.

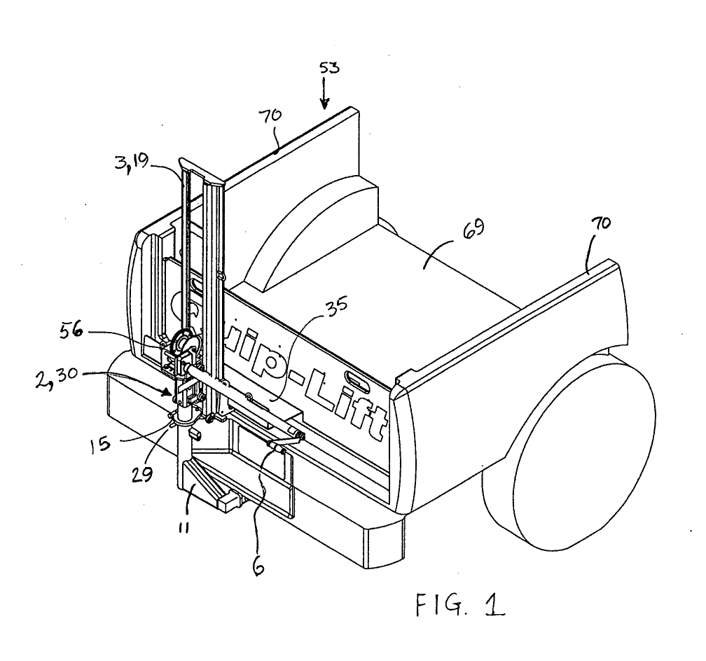

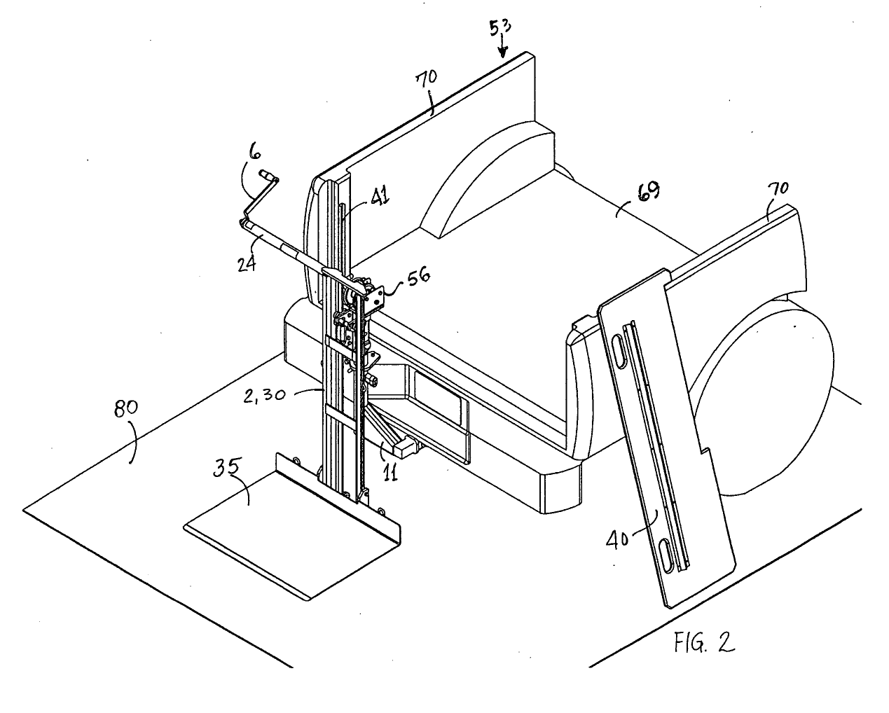

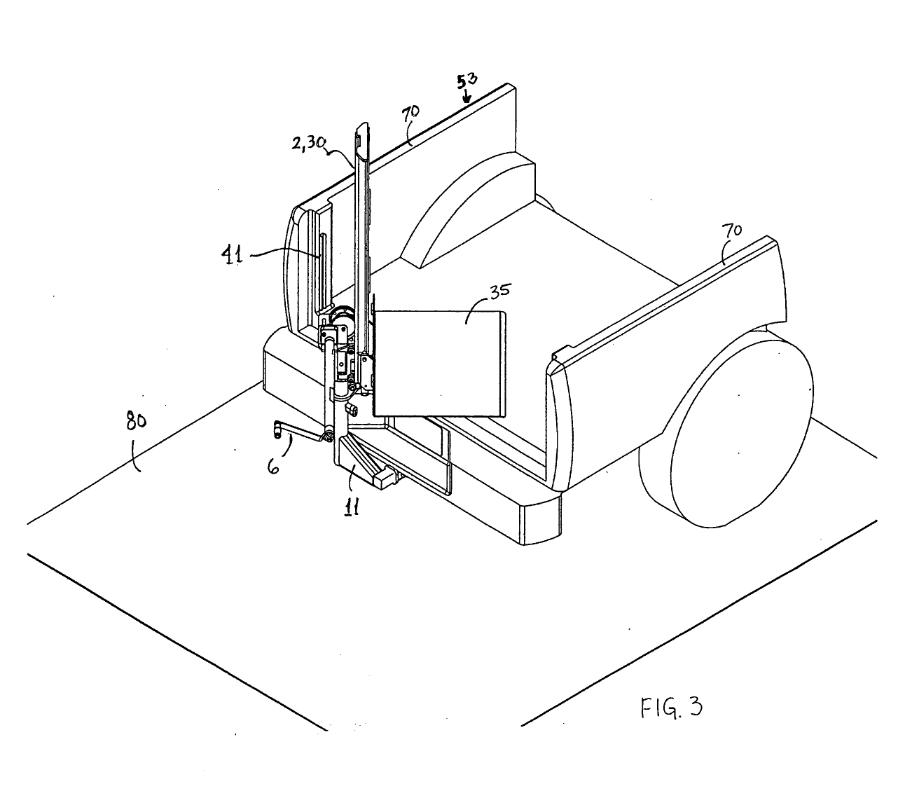

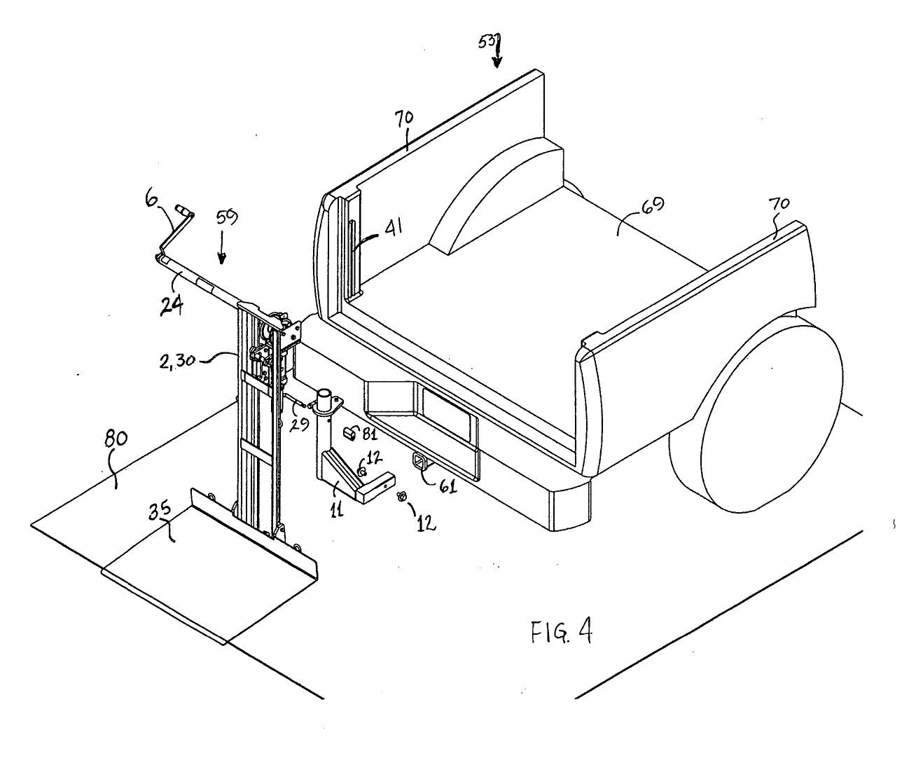

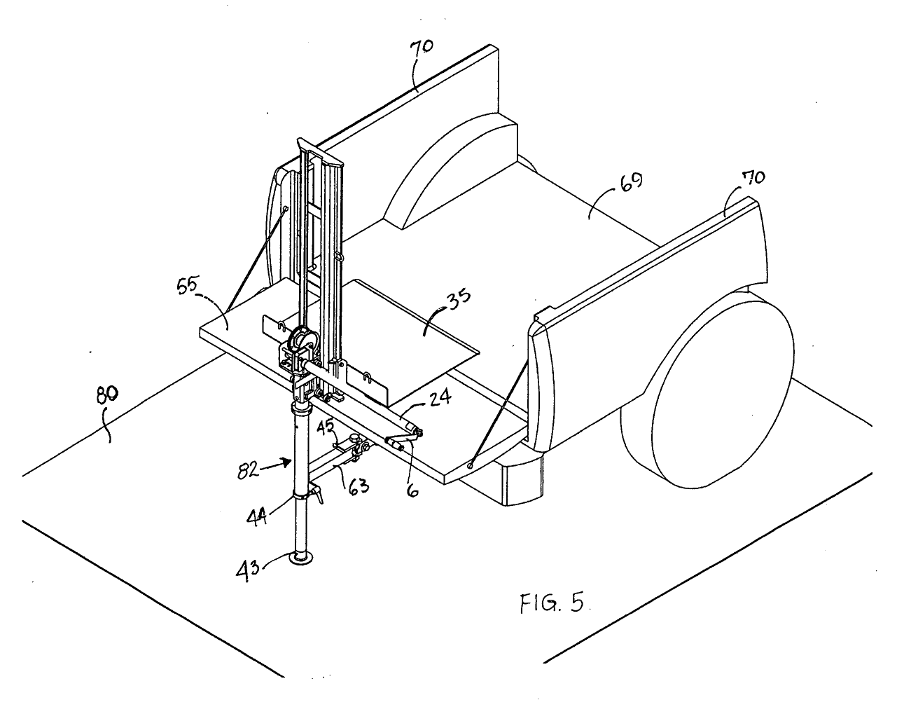

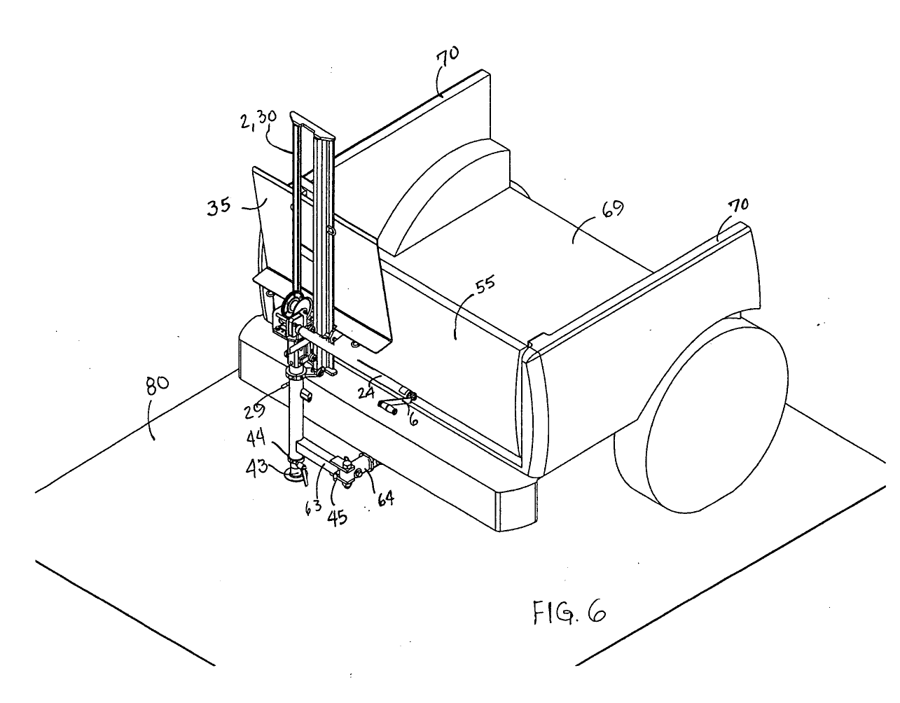

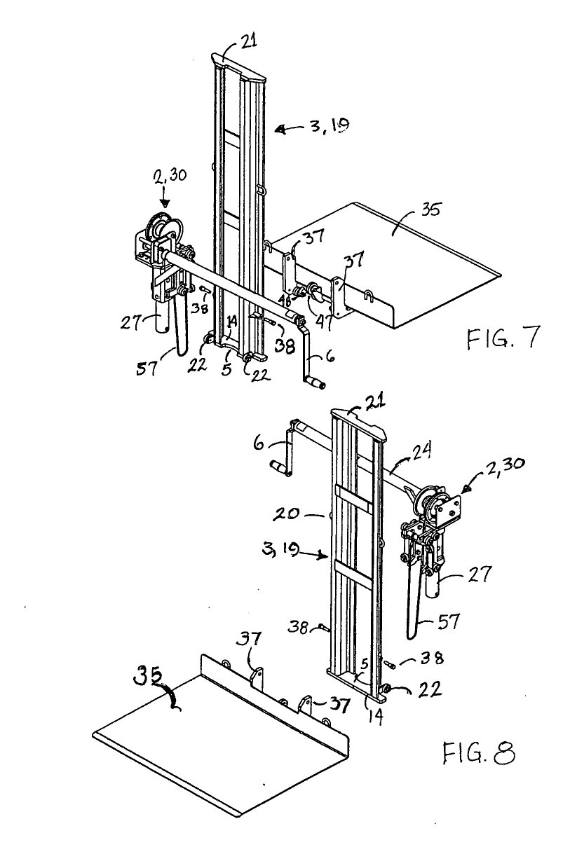

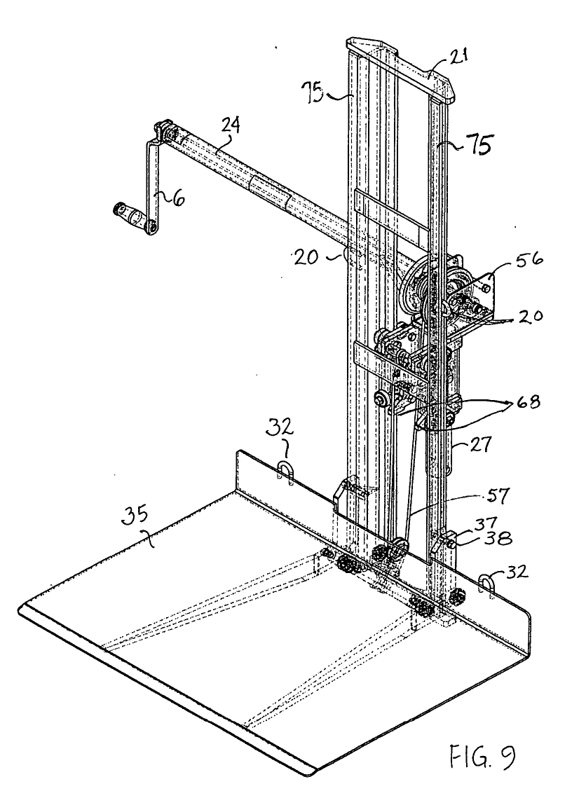

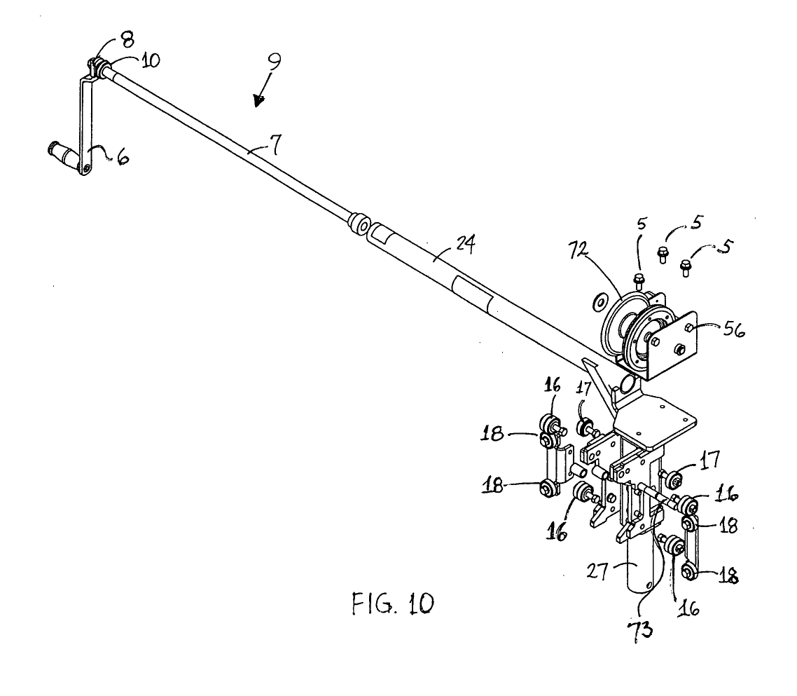

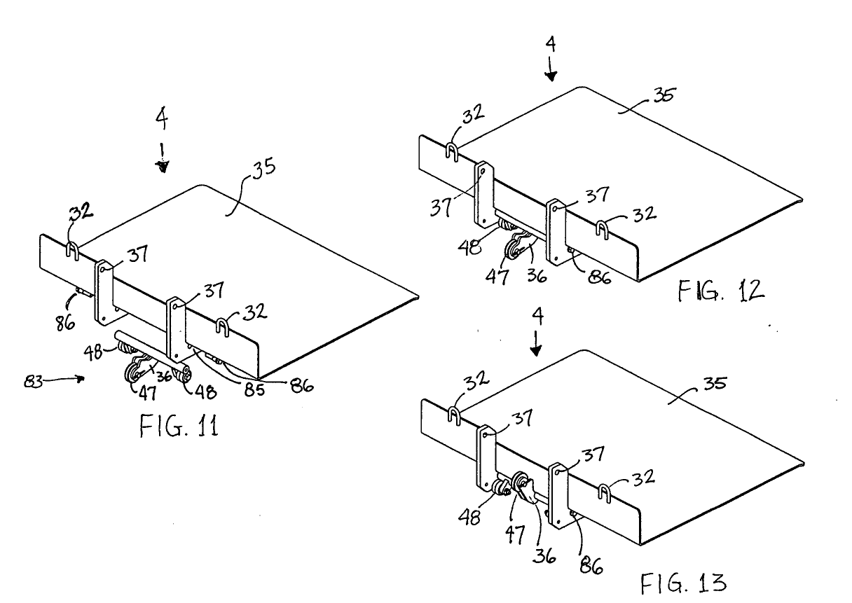

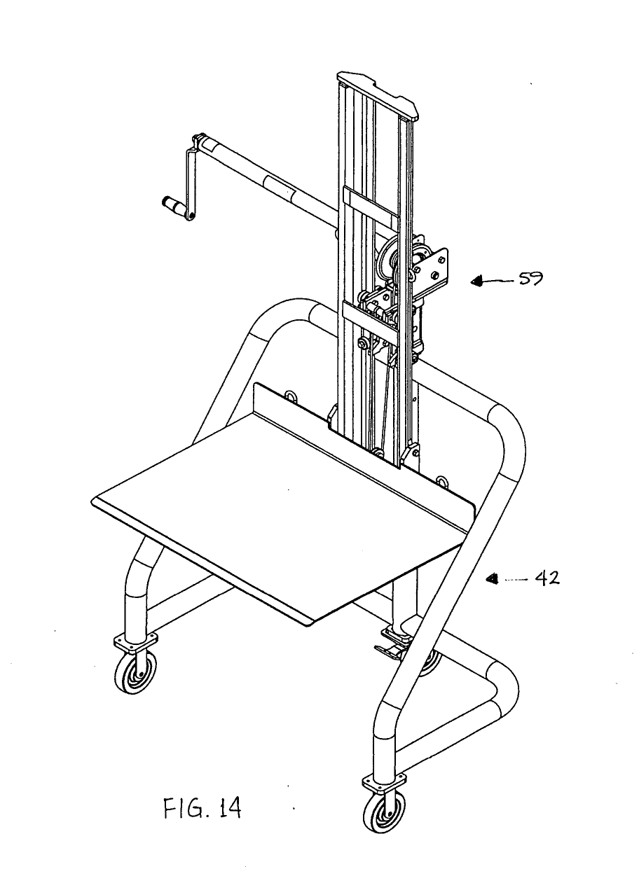

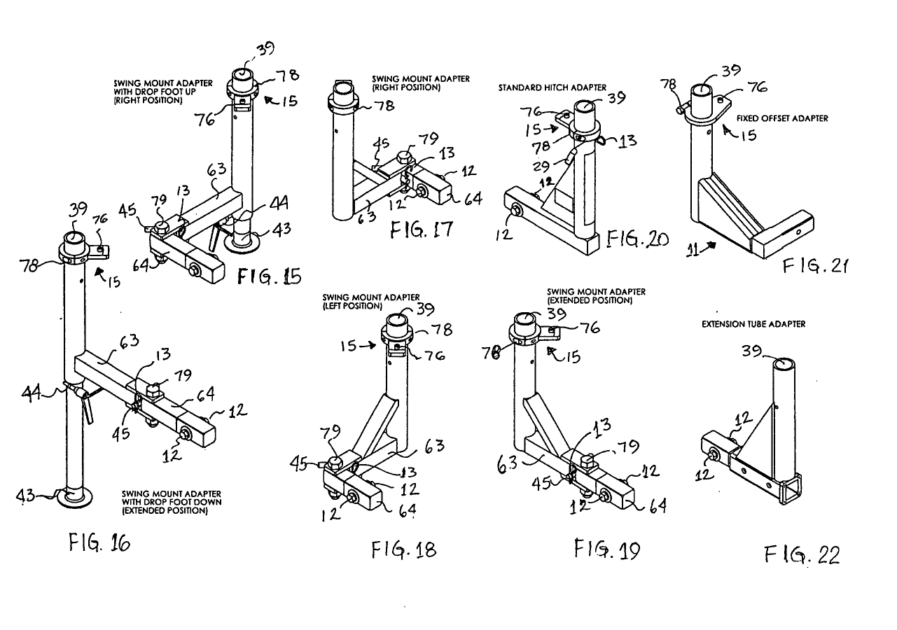

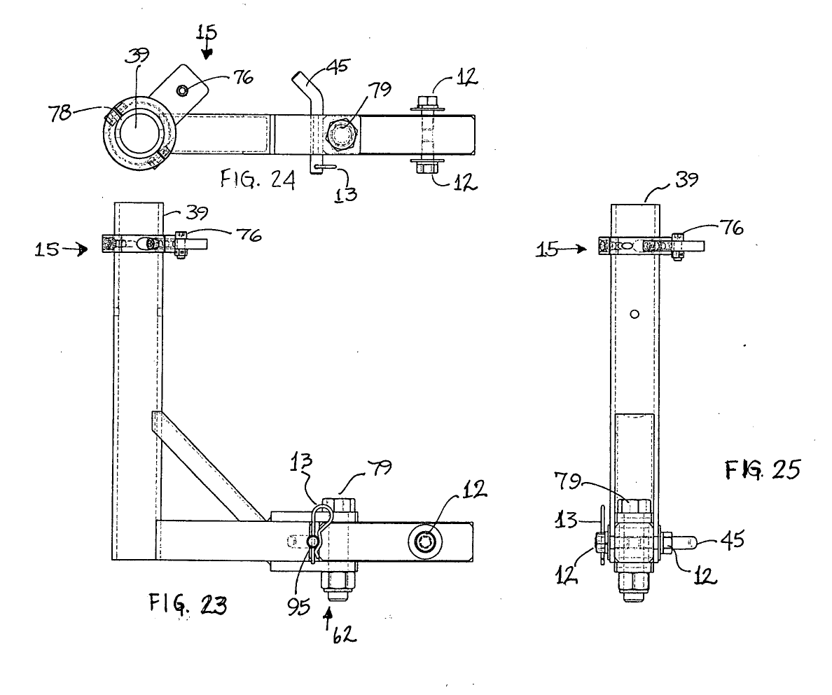

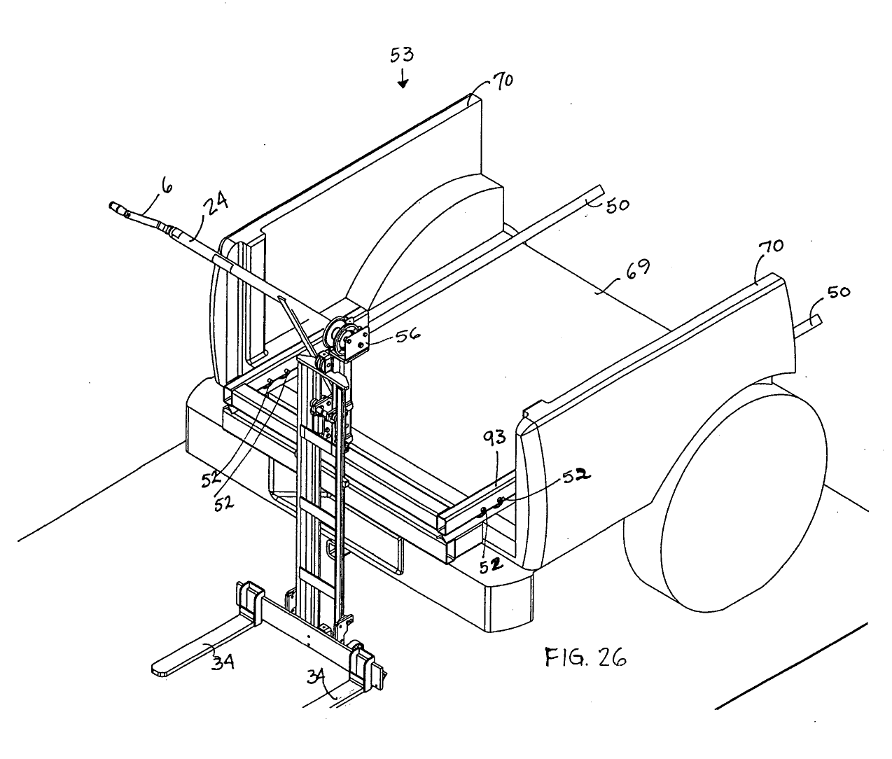

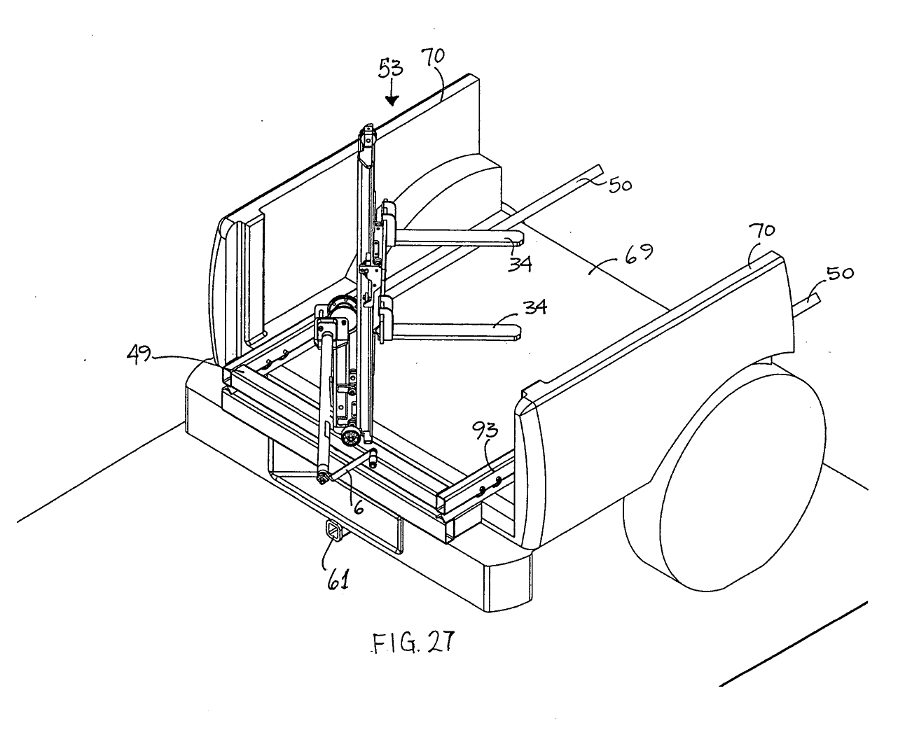

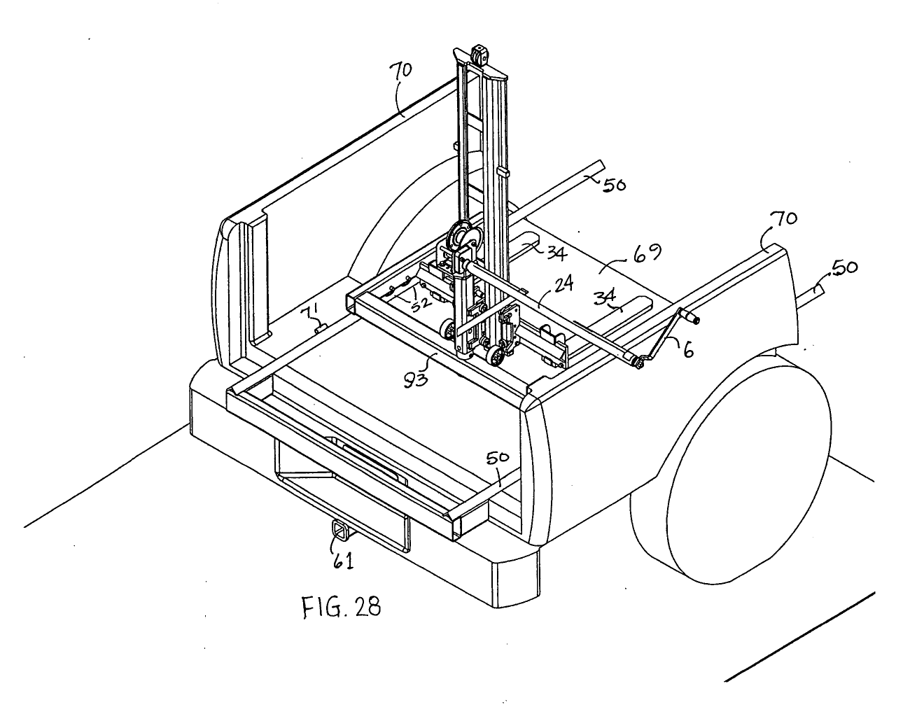

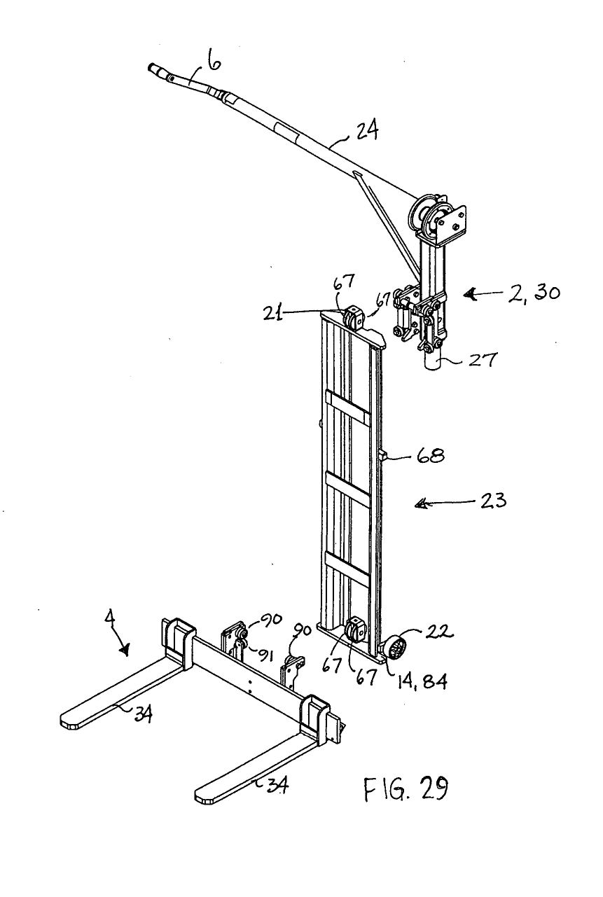

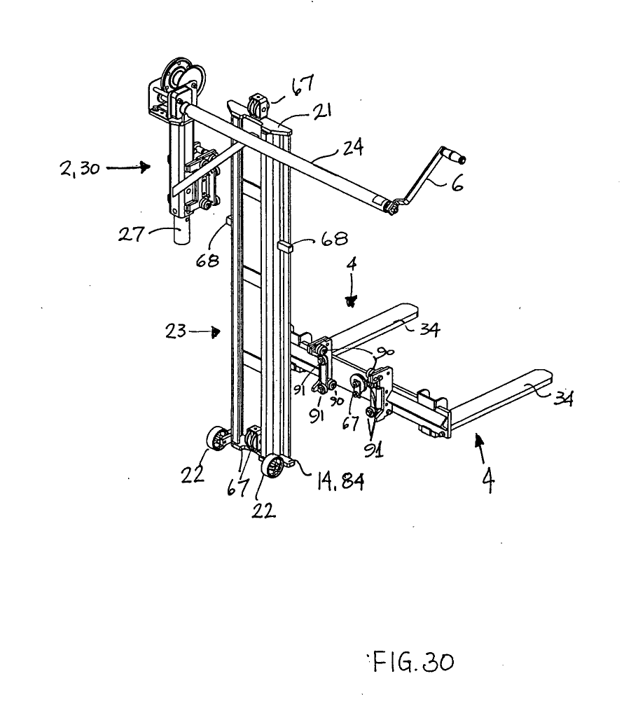

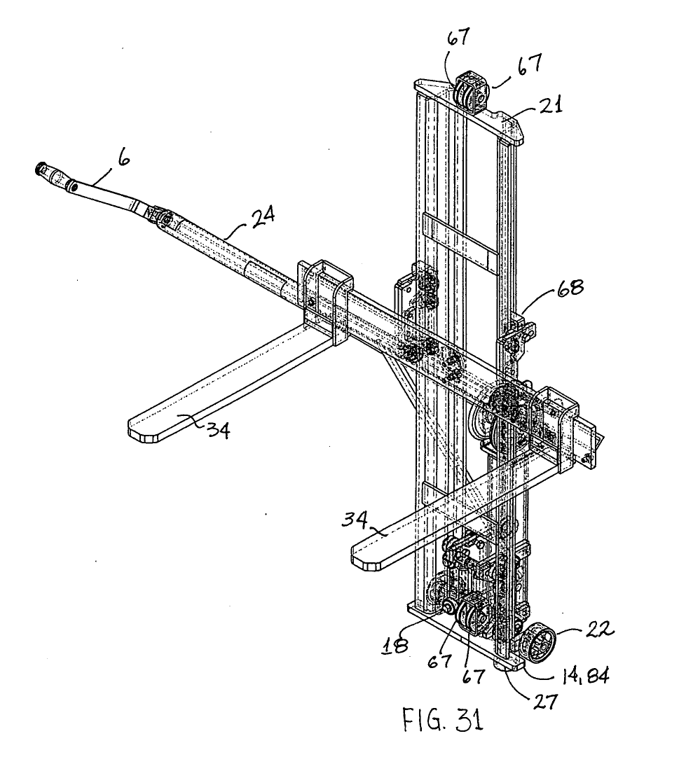

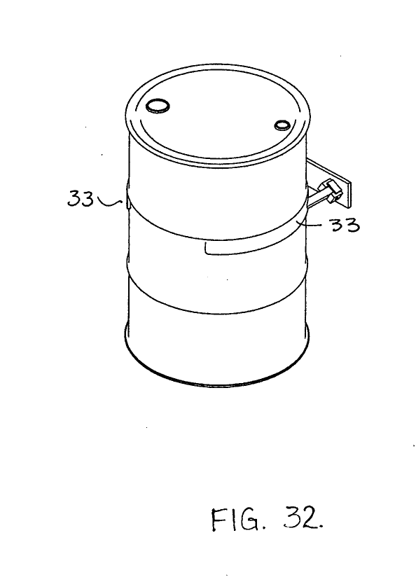

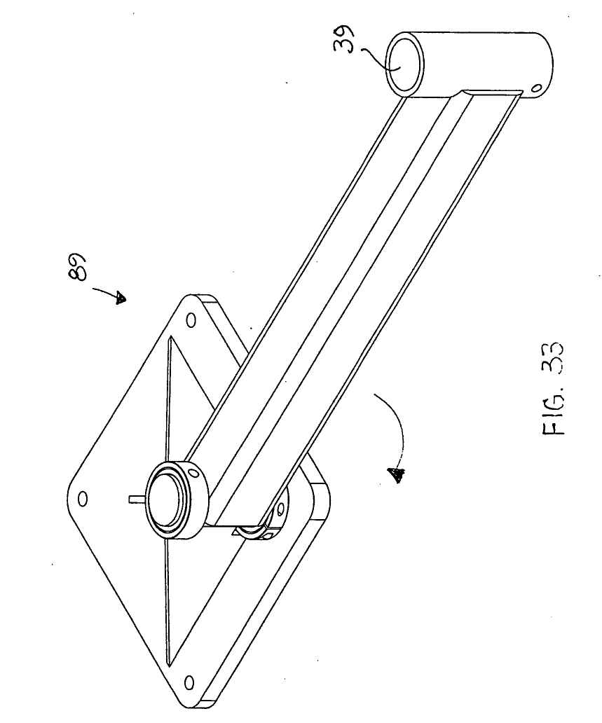

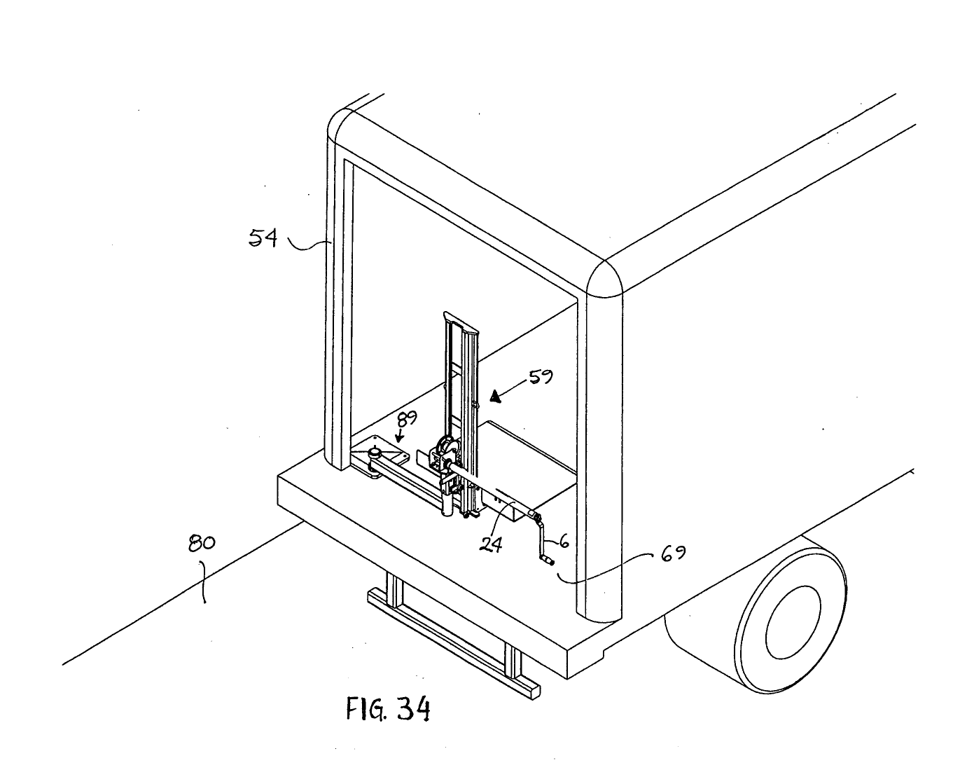

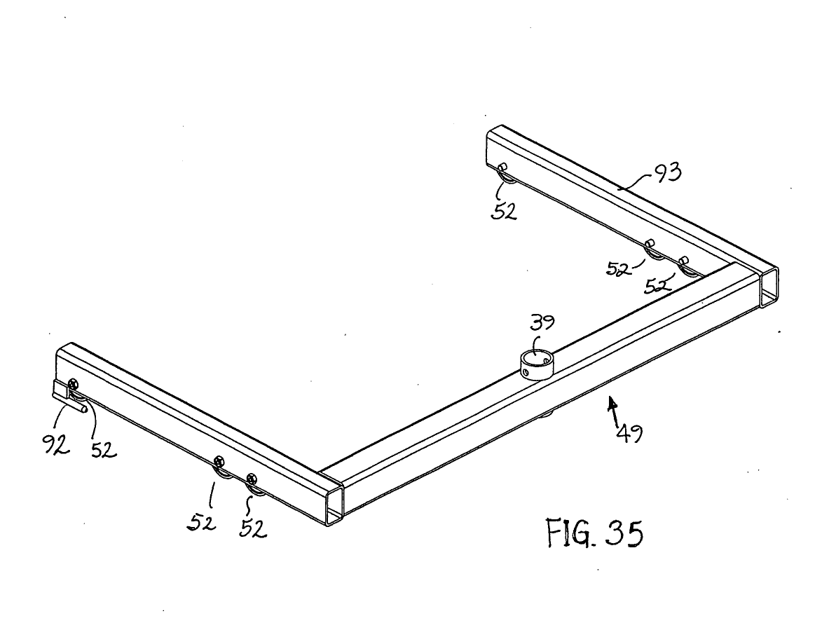

### ITEM REFERENCE

1. Mounting Adapter
2. Pivoting Guide Assembly
3. Elongate Member Assembly
4. Load holding Member Assembly
5. Arc Contour
6. Crank Handle
7. Crank Shaft
8. Crank Handle Retaining Nut
9. Crank handle Assembly
10. Crank Handle Support Bearing
11. Hitch Mounting Adapter (Offset)
12. Hitch Mounting Adapter Bolts
13. Hitch Pin
14. Elongate Member Bottom Cross Member
15. Elongate Member Down Travel Stop
16. Elongate Member Guide Rollers
17. Elongate Member Reverse Thrust Roller Assembly
18. Elongate Member Side Thrust Rollers
19. Elongate Member Single Stage
20. Elongate Member Tie Down- Loops
21. Elongate Member Top Cross Member
22. Elongate Member Transit Rollers
23. Elongate Member Two Stage
24. Pivot Arm
25. Pivot Assembly Elongate Member Load Rollers
26. Pivot Assembly Side Thrust Roller Assembly
27. Pivot Tube
28. Pivot/Transit Lock Pin
29. Pivot/Transit Lock Pin Lock
30. Pivot guide Assembly
31. Load holding Member—Solid
32. Load holding Member Tie Down Loops
33. Load holding Member—Drum Clamps
34. Load holding Member—Adjustable Forks
35. Load holding Member—Solid Tilting
36. Load holding Member Tilt Arm
37. Load holding Member Pivot Points
38. Load holding Member Pivot Mounting Hardware
39. Receiver Tube
40. Sliding Tailgate
41. Sliding Tailgate Channels
42. Straddle Base Accessory
43. Support Foot
44. Support Foot Compression Clamp
45. Swing Arm Joint Lock Pin
46. Swing Arm Adapter
47. Tilt Arm Pulley
48. Tilt Arm Rollers
49. Trolley “U” Frame Assembly
50. Trolley Inverted “V” Track
51. Trolley Mounting Adapter
52. Trolley “V” Groove Wheels
53. Vehicle—Pickup Truck
54. Vehicle—Box Van
55. Vehicle—Factory Tailgate
56. Winch
57. Winch Cable
58. Winch Mounting Bolts
59. Lift Assembly
60. Ground Rollers
61. Hitch Receiver
62. Swing Arm Adapter Joint
63. Swing Arm Pivoting Member
64. Swing Arm Stationary Member
65. Tailgate
66. Pivot guide Assembly Stops
67. Cable Pulleys
68. Load holding member Up Travel Stop
69. Vehicle Bed
70. Vehicle Sidewall
71. Trolley Track Lock Tube
72. Winch Drum
73. Cable Connection Pin
74. Tilt Arm
75. Elongate Member Flange
76. Elongate Member Pivot Stop Pin
77. Swing Arm Mounting Adapter
78. Elongate Member Down Stop Compression Clamp
79. Swing Arm Adapter Pivot Bolt Assembly
80. Ground Level
81. Pivot/Transit Lock Pin Lock
82. Hitch Mounting Adapter with Drop Down Support Foot
83. Tilt Arm Assembly
84. Load holding member Down Travel Stop
85. Tilt Arm Pivot Point
86. Tilt Arm Pivot Hardware
87. Partial Round Contour Cutout
88. Elongate member Up Travel Stops
89. Bolt On Pivot Arm Adapter
90. Load holding member Guide Rollers
91. Load holding member Side Thrust Rollers
92. Trolley Lock Pin
93. Trolley “U” Frame
94. Tilt Arm Pivot Hardware
95. Partial Round Contour Cut

### DETAILED DESCRIPTION OF THE PREFERRED EMBODIMENTS

The illustrated version of the solid load holding member unit has a tilting load holding member (35). The tilting load holding member offers the advantage of providing a smooth transition to each level, without any gaps or joints. This offers significant advantages since the vehicle angle changes with the load in it, and the ground angle in relation to the vehicle varies as well. This tilting load holding member can be created by many means. In the version depicted, a tilt arm (36) with connected tilt rollers (48), raises or lowers the front edge of the load holding member, as the cable becomes tight or slack.

Variations of the load holding member allow the user to load specific items with ease. A drum clamp (33) or hook attachment is available for 55 Gal drums, and fork attachments (34) make it easy to load pallets and larger wheeled items. Many other special load holding members can be configured to load specific items. In the case of water craft applications, special cradle forks that fit the bottom contour of the watercraft are used.

Due to the quick connection feature and variety of mounting means, the main lift assembly (59) can be easily disconnected from one mounting means and transported to another. For instance a user could disconnect the unit from their vehicle hitch receiver and roll it to another vehicle, or mounting location. It could also be transferred to a straddle base accessory (42) that allows the user to use it as a mobile lift load holding member unattached from the vehicle. {Note: A set of ground rollers (60) are attached to the rear of the elongate member assembly (3).} The lift assembly (59) is disconnected from the vehicle by creating slack in the cable when the load holding member and elongate member are fully on the ground. Then with the pivot/transit lock pin (29) removed, the pivot guide assembly (30) is pulled up and out of the mounting adapter (1, 11). The operator can rest the assembly on top of the adapter and secure it at the top of the elongate member. Some users use a bar or “C” clamp to lift the assembly up and secure it at the top of the elongate member for easy installation the next time.

The hitch adapter is mounted to the hitch receiver (61) by two bolts (12). The bolts are used instead of a hitch pin to eliminate any play that exists between the hitch adapter and the receiver. This play could cause the lift to rock or tilt, when rotating the unit with a load.

In many situations there is an advantage to have the unit travel in a position close to the vehicle, and then be able to swing out of the way to open a van door or tailgate. This can be accomplished by using a swing arm adapter (46) that allows the unit to swing out and away from the vehicle. However, when you swing the unit out, the cantilevered load on the mounting means increases, reducing the capacity the lift can support only connected to the vehicle. Thus to retain the full capacity of the lift, a drop down support foot (43) can be lowered to engage the ground to help support the load. In the version shown, the support foot (43) is raised and lowered manually and locked in place by a compression clamp (44). Means such as an acme screw or hydraulic jack could be used to raise and lower this foot, the same way as a trailer jack stand.

The swing joint (62) illustrated is also very unique that it is economical to manufacture, and that the lock pin (45) fits into a fixed gap in the pivot bar joint in three positions. The pin is captured in any of the three positions by a partial round cut in the end of the pivoting joint member (63). Thus, the pin is sandwiched between the round contour cut on the pivoting member (63) and the side of the stationary member (64). In the illustrated versions a hitch pin (13) is used to retain the joint lock pin (45).

For users that want the most lifting capacity, quickest setup without the support foot adapter, the standard offset hitch adapter (11) works with pickups with the tailgate (65) removed. (All recent models of pickup trucks tailgates are removable without tools in less than a minute.) For those users optional sliding up/down tailgate (40) kit is available. The user only has to install two channel members (41) to the sidewalls of the their truck. The channels are mounted forward, so as not to interfere with the factory tailgate (65). The light weight tailgate (40) can be easily slid into or out of the channels (41). Additionally with the factory tailgate removed, it is a lot easier to climb in and out of the vehicle to move loads further forward to a transit position.

Another key variation of this invention is a unit with a two stage elongate member assembly. This feature allows the lift to raise items above the pivot guide assembly stops (66). On this version the load holding member is connected to a second set of rollers {guide (16) and side thrust (18)} that ride on the outside flanges of the elongate member (19). The elongate member travels up and down in relation to the pivot guide assembly (30), and the load holding member (31, 33-35) travels up and down in relation to the elongate member (19). Additional pulleys (67) are mounted at the bottom and top of the elongate member assembly. Depending on where the pulleys are mounted, and how the cable is reaved, the load holding member or the elongate member can be made to raise first. Then when the first moving item hits its upward travel stop, the second item will raise. (The 2^{nd} set of travel stops for the load holding member can either be fixed as depicted (68), or bolt on adjustable. The adjustable stops allow the user to change the upper stop position for their specific vehicle or application.) The travel sequence is created in reverse on the way down. Each variation again has a specific application advantage. On the two stage version depicted, the elongate member (23) lowers first, then the load holding member, or in this case, the forks (34).

In the vehicle application the two stage elongate member adds the ability to raise loads to a height above the bed (69) of the truck such as the sidewalls (70) of a pickup truck. Thus larger/wider items that would hit the sidewall with a single stage elongate member will now pivot clear. Then depending on how wide the item is, it can be lowered down between the sidewalls or set on top. Additionally this second stage guide assembly allows the user to load/unload an item to a third level above the truck bed height. A specific example is that a user could load or unload an item at a commercial truck dock. These docks are usually significantly higher than the height of a standard pickup or van bed.

Also on the two stage version depicted, the elongate member has a larger set of transit rollers (22) on the bottom that contact the ground before the bottom cross brace. If the ground is a hard smooth surface like asphalt or concrete the user could back the vehicle up so that the forks or load holding member would slide under a load such as a pallet or gang box. (Note: This can also be accomplished with a single stage version without the tilting feature.)

A further variation of the unit is one that is mounted to a trolley (49) that rolls back and forth in the vehicle bed. This version allows the user to load and position an item at the front of the vehicle without having to climb into the truck bed. The “U” shaped trolley (49) runs on a set of tracks (50) mounted to the bed of the vehicle. Rollers on the trolley (52) engage the track to guide the trolley in a straight direction in and out of the vehicle. There are a variety of tracks each with an advantage in specific applications. Again like the elongate member, the trolley is guided by sets of rollers to accept the different loads. Each track must take the loads of the trolley when the lift is pointed forward and backwards. The depicted version uses an inverted “V” track (50) and “V” groove wheels (52). In the specific version depicted, pins attached to the trolley “U” tips, engage lock tubes (71) attached to the track at the rear of the truck. These lock pins not only stop the trolley from running off the end of the track, but they will also take the upward loads when the unit is rotated facing out from the truck.

(Raising an item from a lower level (the ground) to a higher level (the truck bed)):

The operator raises the load holding member (31, 33-35) off the truck bed (69), by rotating the crank handle (6) in the clockwise direction.

As the winch (56) is cranked, the cable (57) is wound around the winch drum (72). In this version the cable runs from the winch drum to a pulley (67) attached to the load holding member tilt arm. The other end of the cable is attached to a pin (73) on the pivot guide assembly (30). This creates a two to one cable ratio. This is used since many standard manufactured brake winches have poor gear ratios. The 2 to one cable allows using a standard winch for this version, and does not require extreme handle force. This allows users with varied strengths to raise the load holding member even when fully loaded. As the cable becomes tight it pulls up on the load holding member tilt arm (74).

As the arm pivots, the tilt rollers (48) push against the elongate member flange (75), which pushes the bottom of the load holding member away from the elongate member. The load holding member is connected to the elongate member at two top pivot points (37) one on each side of the elongate member outer flanges. Thus as the load holding member base is pushed away from the elongate member, the load holding member pivots to a position slightly above level. At this point the tilt arm (74) will come in contact with the load holding member and rotation stops.

Now as the winch continues to pull the cable, the elongate member and attached load holding member will raise together.

The elongate member is guided up and down by several sets of rollers attached to the pivot guide assembly (30). Two sets of rollers (16) on each side of the elongate member transfer the forces created by the cantilevered load, to the pivot guide tube assembly (30). Additionally two other sets of rollers (18) transfer any side thrust loads, created by a load not centered side to side on the load holding member.

The load holding member will continue to rise until the bottom cross member (14) of the elongate member comes in contact with the elongate member travel stops (88) mounted to the pivot guide assembly (30).

When the load holding member is fully raised the bottom of the elongate member is also clear of the elongate member pivot stop pin (76) on the down travel stop (15). This pin was captured in an arc contour on the bottom cross brace of the elongate member (5). This prevents the unit from being rotated off the travel stop when the elongate member is not raised and the lock pin (29) is not inserted.

The operator now removes the pivot lock pin (29) and rotates the pivot guide assembly from facing into the vehicle, to facing out.

When the load holding member is facing directly backwards the operator inserts the lock pin (29) again. Note: On more premium versions the lock pin is retained, guided, and spring loaded. An operator only has to pull on a cable below the pivot arm to release the pin and start turning. When the unit is facing straight back the pin snaps back into a second lock pin position.

The operator replaces the pivot/transit lock pin (29) to keep the lift assembly steady and in position during lowering.

Now the load holding member is lowered by rotating the crank handle (6) in the counterclockwise direction, spooling out cable from the drum (72) and allowing the elongate member and load holding member to lower. At any time if the operator releases the crank handle, the load holding member will stay in the current position, held in place by the automatic brake mechanism of the winch (56).

When the bottom of the elongate member contacts the ground the elongate member travel will stop and the load holding member tilt arm (36) will start to rotate down. Eventually the front edge of the load holding member will contact the ground level, unless the vehicle is on extreme terrain conditions. If this were the case it would not be a safe condition to load or unload.

When the load holding member is at the lower level, the operator loads the items to be lifted onto the load holding member (31, 33-35), and secures them as required with straps or rope to the tie down loops(32).

The operator then cranks the winch handle (6) in the clockwise direction to raise the load holding member. The sequence is reverse of the lowering process, where the load holding member tilts to a position slightly above level, and then the elongate member raises up until it contacts the up stops (88).

The operator then again removes the pivot/transit lock pin (29), and rotates the load holding member facing the vehicle again.

The pivot/transit lock pin (29) is replaced, and the operator rotates the handle (6) counterclockwise to lower the load.

As the elongate member lowers, the bottom of the elongate member contacts the elongate member travel stop (15) clamped to the vehicle mounting adapter (1, 11). (Note: This travel stop is adjustable and secured to the adapter by a compression clamp (78). The adjustment allows for variations in height between the mounting point, and the truck bed. It also allows the user the ability to set the incline at which the load holding member will contact the bed.)

Again as the operator continues to crank the handle (6) the load holding member (35) tilts down until the front edge contacts the truck bed.

The operator now removes the load from the load holding member (35) and moves it to the desired position in the truck bed and secures it for transit.

If this is the last item that the operator is going to load, the pivot lock pin (29) is secured with a hitch pin or locking cap. This pivot lock pin is called the transit lock pin since it keeps the pivot guide assembly from rotating or bouncing out of the mounting adapter (11).

Thus is should be apparent that there has been provided in accordance with the present invention a material or equipment lift that fully satisfies the objective and advantages set forth above. Although the invention has been described in conjunction with specific embodiments thereof, it is evident that many alternatives, modifications and variations will be apparent to those skilled in the art. Variations such as changing the lifting means from a winch to something else like a hydraulic ram, rollers being replaced by slide blocks, etc. Accordingly, it is intended to embrace all such alternatives, modifications, and variations that fall within the spirit and broad scope.

1. A vehicle mounted Pivoting lift for moving a load from one level to another comprising:
a. a mounting means for mounting the lift to a vehicle.
b. a guide means pivotally connected to said mounting means for rotation about a vertical axis.
c. an elongate member operatively associated with said guide means and being mounted for vertical reciprocating movement, said elongate member having an upper end and a lower end.
d. a load support member connected to said elongate member and being adapted to support the load.
e. a lift means operatively associated with said guide means for raising and lowering said elongate member.
f. whereby the load support member may be raised or lowered to either level, pivoted over and lowered to that level, such that the load may be fully or partially supported by the level during the loading and unloading process.

2. The lift according to claim 1 comprising multiple elongate members operatively connected to each other by guide means for reciprocating movement in relation to each other to extend the vertical travel distance.

3. The lift according to claim 1 that can be easily dismounted from the vehicle, and relocated to a storage location, or remounted to another vehicle or object.

4. The lift according to claim 3 that has a set of rollers at the end of the elongate member for moving the lift assembly around when it is disconnected from the vehicle.

5. The lift according to claim 1 that can be easily dismounted from the vehicle, and attached to a stand with wheels to allow using the lift in other lifting applications away from the vehicle.

6. The lift according to claim 1 that comprises a pivot means between the elongate member and the support bracket, such that the load support member or load can be tilted to touch a level for easier loading and unloading.

7. The lift according to claim 1 where the mounting means is adapted to fit a vehicle hitch receiver.

8. The lift according to claim 7 where the adapter has another hitch receiver.

9. The lift according to claim 7 where the hitch mounting member is secured to the hitch receiver with mounting screws to limit motion between the hitch receiver and adapter.

10. The lift according to claim 1 where the mounting means has a pivot joint to allow the lift to be moved away from the vehicle so that a door or tailgate can be opened, or to provide clear access to the vehicle.

11. The lift according to claim 10 where the mounting means pivot joint comprises a pin that engages the end of the swing member and the end and sides of the stationary member to lock the pivot joint in one of many positions.

12. The lift according to claim 11 where the mounting means pivot joint swing member end has a partial pin contour cutout to capture the pin.

13. The lift according to claim 1 where the mounting means comprises an extending support means to engage the ground, so that the vehicle mounting means will not be the only support for the lift.

14. The lift according to claim 1 comprising a transit locking means to prevent rotation or disengagement of the lift from the vehicle mounting means when the vehicle is in motion.

15. The lift according to claim 1 comprising tie down means to secure the load when being moved from one level to the other.

16. The lift according to claim 1 where the load support member is adapted for loading and unloading watercraft from a vehicle.

17. The lift according to claim 1 where the load support member is adapted for loading and unloading drums from a vehicle.

18. The lift according to claim 1 where the load support member can fold to a storage position.

19. The lift according to claim 1 where the elongate member or support bracket has a slide or rolling means to engage the ground level, such that the vehicle can be moved to position the support bracket toward or away from the load when the elongate member or support bracket is in contact with the ground.

20. The lift according to claim 1 comprising an extension handle to allow rotation of the lift about he pivot member, and keep the operator clear of the load during operation.

21. The lift according to claim 20 comprising a mechanical lift means such as a winch with a crank handle at the end of the extension handle.

22. The lift according to claim 20 comprising a electric winch lift means, with control switches at the end of the extension handle.

23. The lift according to claim 1 comprising a hydraulic or other lift means.

24. The lift according to claim 1 that comprises a pivot means between the elongate member and the support bracket, such that the load support member or load can be tilted to touch a level for easier loading and unloading.

25. A lift according to claim 1 that comprises a elongate support bracket that has a rotation limiter to prevent pivoting of the load holding member off the edge of a level.

26. A lift according to claim 1 where said vehicle elongate support bracket is adjustable to allow use of a standard adapter for many vehicles with different distances between the mounting point and the vehicle bed.

27. A lift according to claim 1 where
a. the load support member is connected to said elongate member by a second set of guide means.
b. such that the vertical lift means is operatively associated with said first guide means for raising and lowering said elongate member in relation to the first guide means as well as raising and lowering said load support member in relation to the elongate member.

28. The lift according to claim 27 where the elongate member is comprised of two Z cross section members spaced apart in a mirrored parallel configuration, such that the first guide means connects to one set of flanges, and the second guide means connects to the other set of flanges.

29. The lift according to claim 1 where the vehicle factory tailgate has been removed to keep the cantilevered load to the mounting means to a minimum.

30. The lift according to claim 29 where the factory tailgate has been replaced by a slide in tailgate that is contoured to fit the profile of the lift in the transit position.

31. A vehicle mounted pivoting lift for moving a load from one level to another comprising:
a. A mounting means for mounting the lift to a vehicle comprising
i. a pair of elongated tracks adapted for securing to the vehicle bed in a parallel spaced apart relation.
ii. a U-shaped frame having a pair of spaced apart legs and a horizontal crossbar connected and extended between said legs.
iii. means for movably connecting the legs of said frame to said tracks for fore and aft longitudinal movement of said frame on said tracks.
b. a guide means pivotally connected to said mounting means.
c. an elongate member operatively associated with said guide means and being mounted for vertical reciprocating movement, said elongate member having an upper end and a lower end.
d. a load holding member connected to said elongate member and being adapted to support the load.
e. a vertical lift means operatively associated with said guide means for raising and lowering said elongate member.
f. whereby the load support member may be raised or lowered to either level, pivoted over and lowered to that level, such that the load may be fully or partially supported by the level during the loading and unloading process.

32. The lift according to claim 31 comprising multiple elongate members operatively connected to each other by guide means for reciprocating movement in relation to each other to extend the vertical travel distance.

33. The lift according to claim 31 that can be easily dismounted from the vehicle, and relocated to a storage location, or remounted to another vehicle or object.

34. The lift according to claim 31 that has a set of rollers at the end of the elongate member for moving the lift assembly around when it is disconnected from the vehicle.

35. The lift according to claim 31 that can be easily dismounted from the vehicle, and attached to a stand with wheels to allow using the lift in other lifting applications away from the vehicle.

36. The lift according to claim 31 where the elongate member or support bracket has a slide or rolling means to engage the ground level, such that the vehicle can be moved to position the support bracket toward or away from the load when the elongate member or support bracket is in contact with the ground.

37. The lift according to claim 31 that comprises a pivot means between the elongate member and the support bracket, such that the load support member or load can be tilted to touch a level for easier loading and unloading.

38. The lift according to claim 31 comprising a transit locking means to prevent rotation or disengagement of the lift from the vehicle mounting means when the vehicle is in motion.

39. The lift according to claim 31 comprising tie down means to secure the load when being moved from one level to the other.

40. The lift according to claim 31 where the load support member is adapted for loading and unloading watercraft from a vehicle.

41. The lift according to claim 31 where the load support member is adapted for loading and unloading drums from a vehicle.

42. The lift according to claim 31 where the load support member can fold to a storage position.

43. The lift according to claim 31 comprising an extension handle to allow rotation of the lift about he pivot member, and keep the operator clear of the load during operation.

44. The lift according to claim 43 comprising a mechanical lift means such as a winch with a crank handle at the end of the extension handle.

45. The lift according to claim 31 comprising a electric winch lift means, with control switches at the end of the extension handle.

46. The lift according to claim 31 comprising a hydraulic or other lift means.

47. A lift according to claim 31 where
a. the load support member is connected to said elongate member by a second set of guide means.
b. such that the vertical lift means is operatively associated with said first guide means for raising and lowering said elongate member in relation to the first guide means as well as raising and lowering said load support member in relation to the elongate member.

48. The lift according to claim 47 where the elongate member is comprised of two Z cross section members spaced apart in a mirrored parallel configuration, such that the first guide means connects to one set of flanges, and the second guide means connects to the other set of flanges

49. A vehicle mounted pivoting lift for moving a load from one level to another comprising:
a. a mounting means for mounting the lift to a vehicle.
b. a guide means pivotally connected to said mounting means for rotation about a vertical axis.
c. an elongate member operatively associated with said guide means and being mounted for vertical reciprocating movement, said elongate member having an upper end and a lower end.
d. a load support member connected to said elongate member and being adapted to support the load.
e. a lift means operatively associated with said guide means for raising and lowering said elongate member.
f. whereby the load support member may be raised or lowered to either level, pivoted over and lowered to that level.
